(19) United States
(12) Patent Application Publication
(10) Pub. No.: US 2014/0003231 A1
(43) Pub. Date: Jan. 2, 2014

(54) CALL DELAY CONTROL

(71) Applicant: Robert John Salter, Lyndhurst (GB)

(72) Inventor: Robert John Salter, Lyndhurst (GB)

(73) Assignee: BAE SYSTEMS plc, London (GB)

(21) Appl. No.: 14/005,387

(22) PCT Filed: Mar. 16, 2012
(86) PCT No.: PCT/GB2012/050588

§ 371 Date: Sep. 16, 2013

(30) Foreign Application Priority Data
Mar. 17, 2011 (GB) 1104555.6

(51) Int. Cl. H04L 12/805

(52) U.S. Cl. CPC H04L 47/365
USPC 370/229

(57) ABSTRACT

A communications apparatus is disclosed with a first port arranged to receive a first packetised communications signal from a first communications network; a second port arranged to deliver a second packetised communications signal to a second communications network having at least one communications device and to receive a return communications signal from the second communications network; and a call handling controller arranged to pass a received packetised communications signal between the first port and the second port.

The present invention relates to improvements in or relating to call delay control and is more particularly, although not exclusively, concerned with call formatting.

In traditional telephony, that is, circuit switched telephony, for a call to be established between two remote telephones, that is, telephones connected to different local exchanges, signalling is used to establish a path prior to establishing the call itself. The path in the above example comprises initiating telephone to its local exchange, initiating local exchange to trunk connection, trunk connection to receiving local exchange, and receiving local exchange to receiving telephone. Here, the signalling and the call usually take the same path and there is full control of the path through each element in the path. As there is full control, it is relatively straightforward to determine whether a call between two telephones can be established or not.

The trunk connection can be a mesh network, a fixed line or a satellite link.

In conventional satellite telephony a call is routed as above for traditional telephony but the local exchange to trunk connection is a satellite trunk connection and via a base station connection. There is a delay of around 550 to 650 ms in the communication time between the two telephones due to the distance the signal must travel as the satellite is in a geostationary orbit above the earth. The delay is above the human factors limit for holding a conversation between two users. Any interactive communication is limited and the quality of the interactive communication is significantly reduced. Bandwidth for a satellite call is expensive and in some satellite telephony and communications the bandwidth is not efficiently used.

In conventional Internet Protocol (IP) telephony, the local exchanges are replaced by local telephony servers which communicate with one or more trunk telephony servers and routers to establish the path between the initiating telephone and the receiving telephone. A router will establish a path with information on destination IP addresses from the servers. Here, signalling is effected through the trunk telephony server(s) but the call does not take the same path. In this case, the trunk telephony server(s) control the bandwidth which can be used in establishing the call, and if the bandwidth is not sufficient, the call is not established.

An IP voice terminal usually sends traffic in a data stream as a series of short packets. A packet includes a packet header and a packet payload, traffic is loaded into the packet payload for transmission across the communications system. Overall delays in the call are reduced with a small packet size and low latency.

It is an object of the present invention to provide a method of call formatting and delay control that overcomes the disadvantages described above.

In accordance with a first aspect of the present invention there is provided a communications apparatus comprising: a first port arranged to receive a first packetised communications signal from a first communications network;

a second port arranged to deliver a second packetised communications signal to a second communications network comprising at least one communications device and to receive a return communications signal from the second communications network; and

a call handling controller arranged to pass a received said packetised communications signal between the first port and the second port,

the call handling controller comprising a delay monitor;

and a formatting engine arranged to apply a selected packet format to a said first packetised communications signal received by the call handling controller to form a said second packetised communications signal having said selected packet format, wherein;

the delay monitor is arranged to:

obtain a round trip delay for a communications path from the first communications network to the first port, on to the second port, on to the at least one communications device in the second communications network and back to the second port, and back to the first port;

compare the round trip delay with a pre-chosen delay; and

in response to the round trip delay being less than the pre-chosen delay, to generate and transmit a first formatting control signal arranged to cause the formatting engine to apply a first packet format to said first packetised communications signal to form a said second packetised communications signal having said first packet format.

In this way the call handling controller is able to distinguish between a satellite trunk connection and a terrestrial and shorter connection and judge the optimum packet format in which the traffic should be sent. The traffic can then be sent in a high efficiency format (with high latency) and using less bandwidth or in a lower efficiency format (with a low latency of communication) and using greater bandwidth. The format can be chosen as is most appropriate for the communications path.

The assessment can take place in a dynamic manner and does not have to be pre-set or pre-determined by the system or users.

In an embodiment the delay monitor is further arranged to, in response to the round trip delay being more than or equal to the pre-chosen delay, generate and transmit a second formatting control signal arranged to cause the formatting engine to apply a second packet format to said first packetised communications signal to form a said second packetised communications signal having said second packet format. In this way a second format can be applied to the communications signal in a second situation and in response to a different signal to the first formatting signal. In the absence of a first formatting signal, the formatting engine may be arranged in a embodiment to apply a second packet format to said first packetised communications signal to form a said second packetised communications signal having said second packet format. Thus the second packet format can be used in response to a lack of a positive signal in the form of a second formatting signal.

In an embodiment the first packetised communications signal comprises voice packets from a voice terminal in a first communications network. The pre-chosen delay in an embodiment may be 600 milliseconds, ms, and preferably the pre-chosen delay is in the range 400 to 550 milliseconds, ms. This detects and distinguishes transmissions across a satellite link from a communications link in another network.

In the packetised communications signal of an embodiment each packet of a said packetized communications signal comprises a packet header and a packet payload comprising communications traffic and in the first signal format communications traffic is arranged in the packet payload of one or more of said packets so as to comprise no more than 45 percent of each packet. This means that a communications signal sent over a communications link with little delay will be sent in a low latency format in short IP packets and giving the effect of a continuous stream of traffic with no delay.

In another embodiment each packet of a said packetized communications signal comprises a packet header and a packet payload comprising communications traffic and in the second signal format communications traffic is arranged in the packet payload of one or more of said packets so as to comprise in the range 50 percent to 90 percent of each packet. In this arrangement the packets are long packets and comprise a higher percentage of fill of the packet payload. The packets may be delayed prior to or during transmission and are sent with high latency but using a lower bandwidth requirement than packets sent with a low latency and a higher efficiency. In a particular embodiment of a communications apparatus the second signal format traffic communications traffic is arranged in the payload of one or more of said packets so as to comprise at least 80 percent of each packet.

The first communications network may comprise a trunk network. The second communications network in an embodiment may include a satellite communications link. In a further embodiment, each communications network comprises a packet switched network and the communications signals comprise continuous streams of packets. The data and traffic may comprise an Internet Protocol, IP, format, comprising IP packets. In particular the data in this embodiment may comprise a Voice Over Internet Protocol, IP, VoIP, communications format.

An IP voice terminal in this type of system can thus send voice traffic in a manner that is optimal for, and matched to, the bandwidth and delay of the particular communications path.

In an embodiment the communications apparatus further comprises a trial communications signal generator arranged to generate and transmit a trial packetised signal and the delay monitor is further arranged to measure a said round trip delay of the trial packetized signal round said communications path. In this way a trial signal burst can be sent around the communications path to determine the delay and hence set an appropriate formatting control signal.

In accordance with a second aspect of the present invention, there is provided a method of transmitting communications traffic from a first communications network to a second communications network, the method comprising the steps of;
1. a) receiving a first packetised communications signal from a first communications network;
2. b) delivering a second communications signal to a second communications network comprising at least one communications device;
3. c) passing a received communications signal from the first communications network to the second communications network;
4. d) obtaining a round trip delay for a communications path from the first communications network on to the at least one communications device in the second communications network and back from the second communications network to the first communications network;
5. e) comparing the round trip delay with a pre-chosen delay;
6. f) generating and transmitting a first formatting control signal arranged to cause packets to be formatted in a first format if the round trip delay is less than the pre-chosen delay; and
7. g) formatting a packetised communication signal in dependence on the formatting signal.
8. In an embodiment the method further comprises generating and transmitting a second formatting control signal arranged to cause packets to be formatted in a second format if the round trip delay is more than or equal to the pre-chosen delay. In this way the second formatting signal can be implemented if required.
9. In an embodiment a method of call handling control for continuous streams of communications data packets in a packet switched network includes at least two local area networks in communication with one another across a connecting network, in this embodiment the method comprises the steps of:
a) determining an acceptable packet size delay for a call which is to be established between two of the local area networks;
b) comparing actual packet delay rate to the acceptable packet delay; and
c) implementing a large packet size if the delay is greater than the acceptable packet delay. In this embodiment the method of step b) includes the steps of;
1. d) transmitting a burst of trial data from a first node in the first local area network through the connecting network to a second node in the second local area network;
e) reflecting the burst of trial data received at the second node back to the first node;
f) receiving the reflected burst of trial data at the first node through the connecting network; and
g) comparing the reflected burst of trial data to the transmitted burst of trial data to determine whether a larger packet size can be initiated for the communications traffic from the first node in the first local area network to the second node in the second local area network.

In an embodiment the method further includes the step of storing data relating to delayed packets for future use.

In the following description traffic is used to describe both voice traffic and data traffic that may be transmitted across a communications link in a communications network. For example, communications traffic can comprise voice data in the traffic as well as other forms of message data, such as client data from the client network.

The formatting control signal generated by the formatting engine is issued to designate a type of formatting of the traffic packets. The description of the percentage of fill of the payload of the packet refers to the percentage of fill of the payload relative to the entire packets size i.e. the relative size of the packet payload. The formatting signal defines how many frames are in a packet with a fixed header size and fill.

Trunk network is used to describe the main communications link to which a number of communications networks can be attached and through which communications pass.

For a better understanding of the present invention, reference will now be made, by way of example only, to the accompanying drawings in which:—

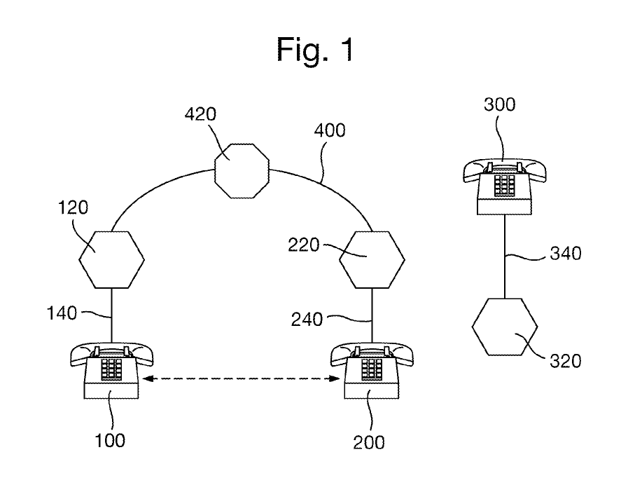

FIG. 1 illustrates a conventional circuit switched telephony network;

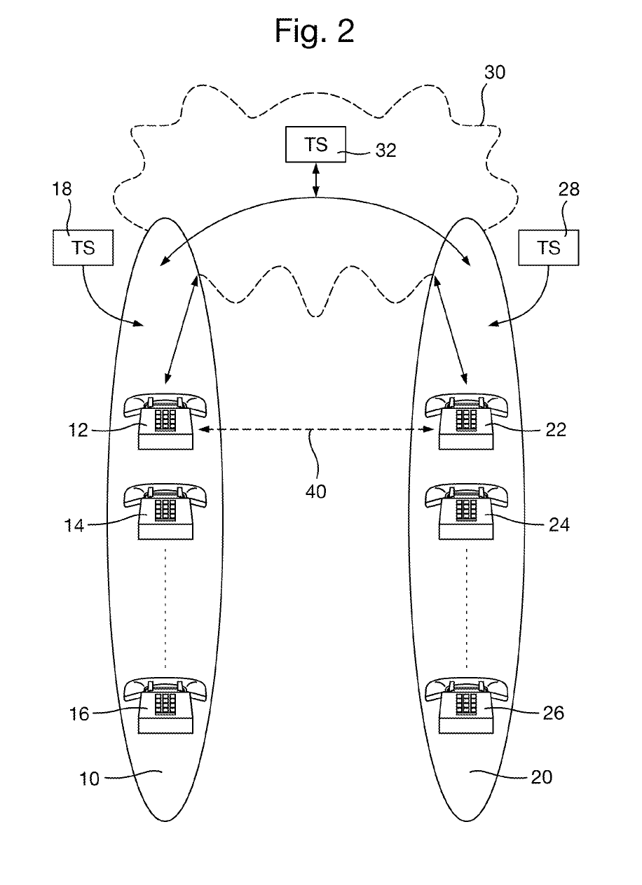

FIG. 2 illustrates a conventional IP telephony network;

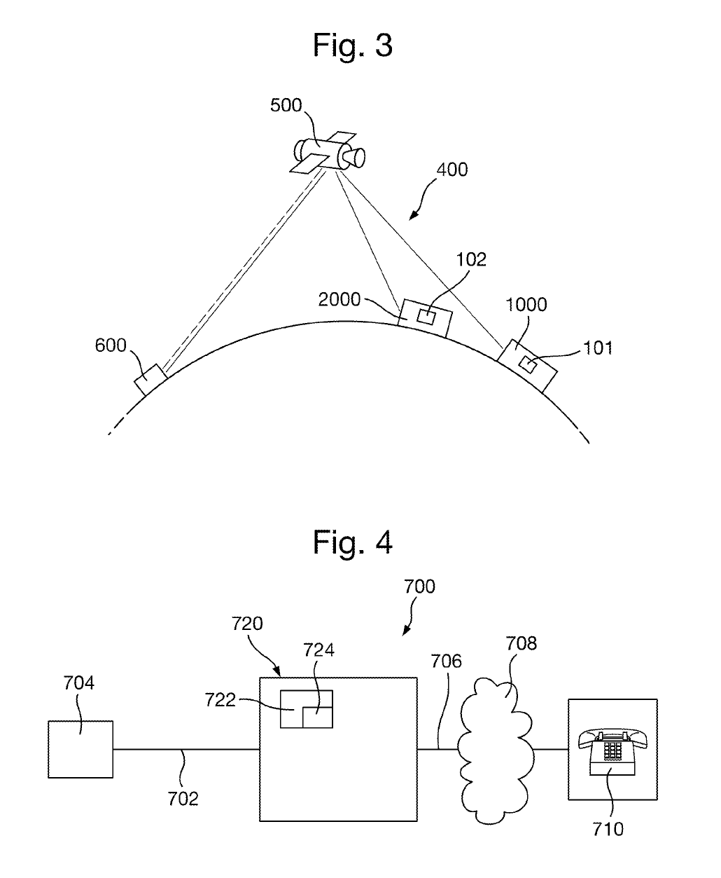

FIG. 3 illustrates an IP telephony link including a satellite link;

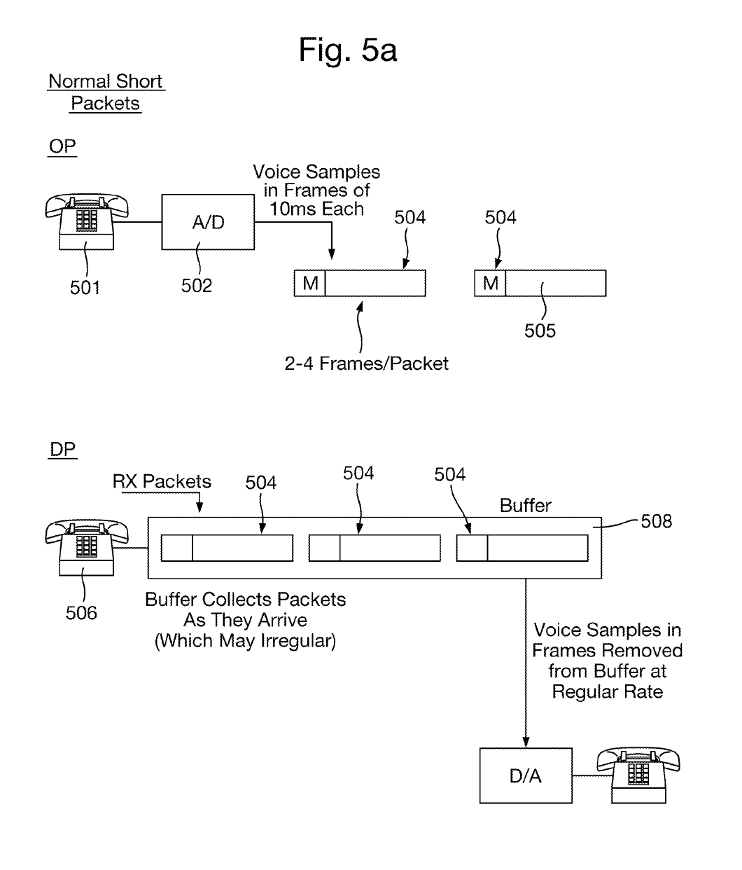

FIG. 4 illustrates a schematic diagram of the components of the apparatus of the present invention

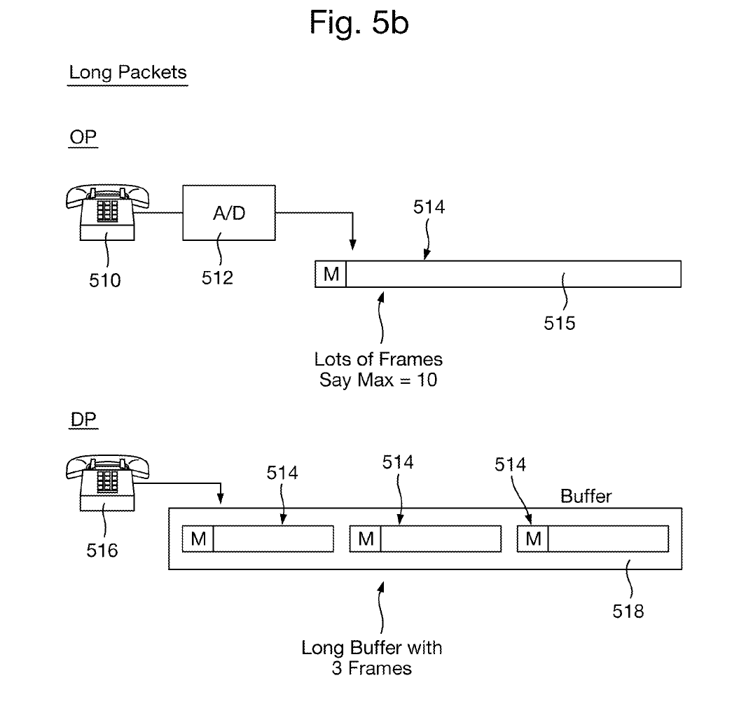

FIG. 5a is a schematic diagram showing a communications signal in a first format in accordance with the present invention;

FIG. 5b is a schematic diagram showing a communications signal in a second format in accordance with the present invention; and

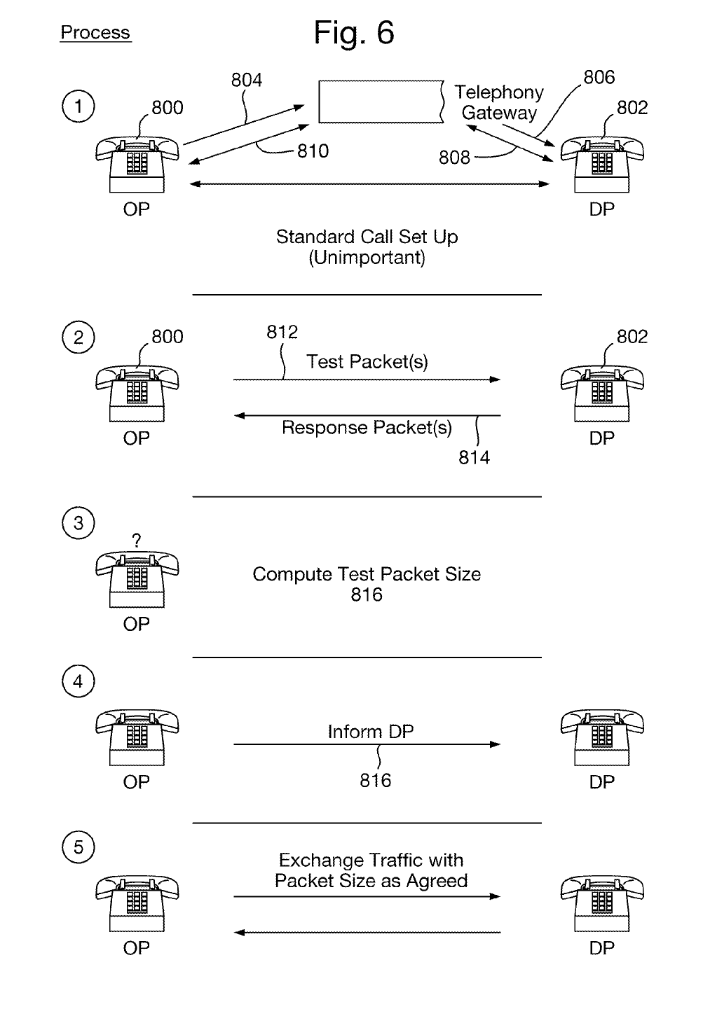

FIG. 6 is a diagram showing the operational steps for implementing a call set up in the present invention.

Referring initially to FIG. 1, a plurality of telephones 100, 200, 300 connected to respective local telephone exchanges 120, 220, 320 by respective lines 140, 240, 340. If a call is to be made between an originating telephone 100 and a destination telephone 200, the call must be routed via exchange 120, trunk connection 400 and exchange 220. Here, the trunk connection 400 includes a trunk exchange 420 which determines whether the call can be established.

Similarly, if a call is to be made between telephone 100 and telephone 300, it is routed from telephone 100 via exchange 120, a trunk connection (not shown) between exchange 120 and exchange 320, and exchange 320 to telephone 300.

Naturally, each exchange 120, 220, 320 has more than one telephone 100, 200, 300 connected to it and other trunk connections are provided between pairs of exchanges 120, 220, 320.

Referring now to FIG. 2, two networks 10, 20 are shown which are connected to one another via a connecting network 30. Network 10 includes a plurality of telephones 12, 14, 16 and a telephony server 18 and network 20 includes a plurality of telephones 22, 24, 26 and a telephony server 28. Telephony servers 18, 28 are known as ‘local’ telephony servers and each telephony server 18, 28 controls calls made into and out of its associated network 10, 20. The telephony servers may include network information such as address and directory lists for directing and routing calls.

Although three telephones are shown in each network, it will be appreciated that the number of telephones in each network may be any suitable number in accordance with the application of the network. It will also be appreciated that one network may have a different number of telephones to the other network.

As shown, connecting network 30 also includes a telephony server 32 for controlling the calls routed through the network 30. Telephony server 32 is known as a ‘trunk’ or intermediary telephony server.

It will be understood that if telephone 12 in network 10 wants to make a call to telephone 22 in network 20, as indicated by the dotted arrow 40, the call is routed from telephone 12 to telephony server 18 for onward routing through the connecting network 30. In the connecting network 30, the call is routed with assistance from telephony server 32 and then to telephony server 28 in network 20 prior to being routed to telephone 22.

The traffic is often transmitted in short bursts or in short packets to best utilise the bandwidth available and avoid delays in the call. Bandwidth and bandwidth limitations are described in more detail below.

Referring now to FIG. 3, two networks 1000, 2000 are shown, including telephones 101 and 102. The networks are connected to one another via a connecting network 400 and here the trunk connection uses a satellite 500 to make the trunk link. The link includes communication back to a base station 600. The link may also include a ‘double hop’ or double routing through a satellite 500 or another satellite depending on the communication path constraints. A double use of a satellite link will result in double the delay.

The networks and communication described are appropriate to terrestrial communication systems and to packet based systems (IP communication systems). In Internet Protocol, IP, telephony traffic is in the form of a packetised communications signal.

The IP packets comprise a packet header and a packet payload. The payload is usually of a fixed length and contains routing, coding and signalling information. The packet payload contains data, client data from another network and may include some redundancy functions. Data is included in packets as frames made up of sampling information representing a voice signal. The sampling and coding of a signal can be considered as a standard procedure and will not be discussed further here. For a signal typically sampled at a rate of 8000 samples per second the signal can be represented in binary, digital form as 16 bits. Frame size is typically 10 milliseconds, ms, i.e. comprises 80 samples at a sampling rate of 8000 samples per second. Data compression and approximation under the internet telephony standards and communications protocols, such as the G729 audio data compression algorithm can result in representation of these 10 millisecond samples with just 1 bit. By converting into bytes of information this leads to 10 bytes in one frame. A packet header can be around 40 bytes, and can be up to 52 bytes. The more frames in a packet payload the longer it will take to be filled with voice samples and thus longer before transmission from the IP system to another network can occur. A short packet may contain between 1 to 3 frames per packet and a long packet may contain between 5 to 10 frames per packet. Delay in transmission is undesirable as this can lead to call disruption and is not easy for another network or a user in another network to receive and understand. Some delay can occur in sampling a voice signal and in routing through network routers and apparatus. The delay is of the order of 1 millisecond and is not significant.

A short packet will therefore have a smaller proportion of its total as the packet payload than a long packet. This means that short packets can be considered to be less efficiently loaded as they have small packet payloads when compared to a fixed header size. A frame arranged with short packets is shown in FIG. 5a. A large bandwidth is required for transmission however, a short packet can be filled with voice samples more quickly than a long packet and there is often only a short delay prior to transmission whilst a packet is being filled. For this reason short packet communication is often used over terrestrial links. In a terrestrial link bandwidth can be readily available but delay is undesirable. In contrast, when satellite links are used between a source and destination network, as set out above, the resulting round trip delay is in the order of 550 to 650 milliseconds. Such a delay is above the human factors limit for communication with an interactive voice call so there is no value in minimising packet filling delays as the major delay is the round trip satellite delay. In addition satellite bandwidth is costly, therefore long packets, efficiently loaded with a large payload relative to a fixed header size are desirable. A frame arranged with long packets is shown in FIG. 5b.

FIG. 5a illustrates an originating phone handset 501 in a communications system. A voice signal undergoes sampling and conversion at an analogue to digital converter 502 and digital voice samples are shown in short packets 504 comprising a packet payload 505 of between 2 to 4 frames.

A destination phone and a phone handset 506 receives the packetised communication signal and collects the short IP packets in a buffer 508 from which they are removed and decoded at a regular rate.

FIG. 5b illustrates an originating phone and phone handset 510 in a communications system. A voice signal undergoes sampling and conversion at an analogue to digital converter 512 and digital voice samples are shown in long packets 514 comprising a packet payload 515 of up to 10 frames. The packet payload makes up a significant proportion of the entire packet size (combination of packet header, H, and packet payload).

A destination phone and phone handset 516 receives the packetised communication signal and collects the long IP packets in a buffer 518 from which they are removed and decoded at a regular rate. Buffer 518 is necessarily larger than buffer 508.

The communications apparatus and call handling controller are shown in FIG. 5 and comprise apparatus 700 connected to a first port 702 arranged to receive a first communications signal from a first communications network 704. The communication signal is capable also of transmission to the first communications network. In the embodiment described the communication signal is a VoIP traffic packet. The apparatus 700 is also connected to a second port 706 arranged to deliver a second communications signal to a second communications network 708 comprising at least one communications device 710 and to receive return communication traffic from the second communications network 708. The apparatus is also includes a call handling controller 720 arranged to pass received communications traffic from the first port to the second port. The call handling controller 720 further includes a delay detector 722 and a formatting engine 724, the delay detector 722 is arranged to monitor a round trip delay for traffic passed from the first communications network to the first port to the second port, on to the at least one communications device and returned back from the second communications network to the first port.

The formatting engine 724 is then arranged to compare the round trip delay time with a pre-chosen delay and to format communication traffic in a first format if the round trip delay rate is less than the pre-chosen delay rate.

The round trip delay can be used to distinguish a satellite communications link from a terrestrial communication link, for example where the network 708 includes a Satellite Communication, SATCOM, communication channel.

The mechanism in operation is best illustrated with reference to FIG. 6.

In operation, at scenario 1, the method of transmitting communications traffic from an originating phone in a first communications network 800 to a destination phone in a second communications network 802, comprises the steps of;
10. a) receiving a first packetised communications signal 804 from a first communications network 800;
11. b) delivering a second communications signal 806 to a second communications network 802 comprising at least one communications device;
12. c) passing a received communications signal from the first communications network 800 to the second communications network 802;
13. d) obtaining a round trip delay for a communications path from the first communications network on to the at least one communications device in the second communications network and back from the second communications network 808 to the first communications network 810;
14. e) comparing the round trip delay with a pre-chosen delay;
15. f) generating and transmitting a first formatting control signal arranged to cause packets to be formatted in a first format if the round trip delay is less than the pre-chosen delay; and
16. g) formatting a packetised communication signal in dependence on the formatting signal.

With reference to steps 2 to 5 of FIG. 6 the method may require that telephones such as originating phone 800 which are setting up a call will send a trial burst of ‘ping’ packets 812 to the telephone which they are attempting to call before they send the signalling message which will cause the other telephone 802 to ring. This ‘delay probe’ might use four or five ping packets of the same size and priority as the voice packets that will be used when the call is in voice but more closely spaced in time. By analysing the returned packets 814, the telephone can decide how to format the packets 816 of the communications signal. The optimal number and spacing of these trial bursts (pings) can be chosen in accordance with the requirements of a particular network or system.

The decision of a change in formatting of the communications signal may be made by the telephone initiating the call, by another telephone or element in the same local network as initiating telephone, or by a human operator.

Whilst the present invention has been described with reference to calls being made from one telephone to another, it will be appreciated that the present invention is equally applicable to other types of real time traffic. Such traffic, for example, transmissions and communications, include management and signalling transmissions (rate limited), video transmissions and data transmissions. Real time traffic can be described as delay-sensitive traffic for example traffic involving some form of interaction with another party such as chat, instant messaging, interactive video or other types of interactive communications such as might arise with cloud computing applications. Traffic can be transmitted in the form of Internet Protocol (IP) packets. The traffic may comprise continuous streams of data and may be rate limited. Each packet may be encrypted for secure transmission in accordance with a suitable packet cryptograph. Encryption is carried out in the local network by the transmitting node or another node and/or another element (not shown) located within that network.

Other steps in addition to those listed above or alternatives may be included. A combination of steps and apparatus features may be used.

Other embodiments within the scope of the present invention may be envisaged that have not been described above for example, a group of networks or network elements could be connected in any way. It will readily be appreciated that it is possible to prioritise traffic within an IP network so that certain types of traffic have particular priorities. It will also be appreciated that the priority of the traffic can be altered as required, these factors can be taken into account in the setting of packet size if required. One or more call handling controllers or formatting engines could be used.

Although not illustrated for the embodiments described, other types of traffic and messages can also be allowed to pass across the system. The setting of a pre-chosen delay can instead be a dynamic design feature and can be set to a particular system requirement or assessed and set for each communication signal or communications system.

1. A communications apparatus, comprising:
a first port arranged to receive a first packetized communications signal from a first communications network;
a second port arranged to deliver a second packetized communications signal to a second communications network having at least one communications device and to receive a return communications signal from the second communications network; and
a call handling controller arranged to pass a received said packetized communications signal between the first port and the second port, the call handling controller including:
a delay monitor;
and a formatting engine configured to apply a selected packet format to a said first packetized communications signal received by the call handling controller to form a said second packetized communications signal having said selected packet format, wherein;
the delay monitor is configured to:
obtain a round trip delay for a communications path from the first communications network to the first port, on to the second port, on to the at least one communications device in the second communications network and back to the second port, and back to the first port;
compare the round trip delay with a pre-chosen delay; and
in response to the round trip delay being less than the pre-chosen delay, to generate and transmit a first formatting control signal arranged to cause the formatting engine to apply a first packet format to said first packetized communications signal to form a said second packetized communications signal having said first packet format.

2. A communications apparatus according to claim 1, wherein the delay monitor is configured to, in response to the round trip delay being more than or equal to the pre-chosen delay, generate and transmit a second formatting control signal arranged to cause the formatting engine to apply a second packet format to said first packetized communications signal to form a said second packetized communications signal having said second packet format.

3. A communications apparatus according to claim 1, wherein, in an absence of a first formatting signal, the formatting engine is configured to apply a second packet format to said first packetized communications signal to form a said second packetized communications signal having said second packet format.

4. A communications apparatus according to claim 1, wherein the first packetised communications signal includes voice packets from a voice terminal in a first communications network.

5. A communications apparatus according to claim 1, wherein the pre-chosen delay is in a range of 400 to 600 milliseconds, ms.

6. A communications apparatus according to claim 1, wherein each packet of a said packetized communications signal comprises:
a packet header and a packet payload containing communications traffic and in the first signal format communications traffic is arranged in the packet payload of one or more of said packets so as to include no more than 45 percent of each packet.

7. A communications apparatus according to claim 2, wherein each packet of a said packetized communications signal comprises:
a packet header and a packet payload containing communications traffic and in the second signal format communications traffic is arranged in the packet payload of one or more of said packets so as to include in a range 50 percent to 90 percent of each packet.

8. A communications apparatus according to claim 2, wherein in the second signal format traffic communications traffic is arranged in the payload of one or more of said packets so as to include at least 80 percent of each packet.

9. A communications apparatus according to claim 1, wherein the first communications network comprises:
a trunk network.

10. A communications apparatus according to claim 1, wherein the second communications network comprises:
a satellite communications link.

11. A communications apparatus according to claim 1, wherein each communications network comprises:
a packet switched network and the communications signals include continuous streams of packets.

12. A communications apparatus according to claim 11, wherein the data comprises:
an Internet Protocol, IP, format, having IP packets.

13. A communications apparatus according to claim 11, wherein the data comprises:
a Voice Over Internet Protocol, IP, VoIP, communications format.

14. A communications apparatus according to claim 1, comprising:
a trial communications signal generator configured to generate and transmit a trial packetised signal, and the delay monitor is configured to measure a said round trip delay of the trial packetized signal round said communications path.

15. A method of transmitting communications traffic from a first communications network to a second communications network, the method comprising:
a) receiving a first packetised communications signal from a first communications network;
b) delivering a second communications signal to a second communications network having at least one communications device;
c) passing a received communications signal from the first communications network to the second communications network;
d) obtaining a round trip delay for a communications path from the first communications network on to the at least one communications device in the second communications network and back from the second communications network to the first communications network;
e) comparing the round trip delay with a pre-chosen delay;
f) generating and transmitting a first formatting control signal arranged to cause packets to be formatted in a first format if the round trip delay is less than the pre-chosen delay; and
g) formatting a packetised communication signal in dependence on the formatting signal.

16. A method as claimed in claim 15, comprising:
generating and transmitting a second formatting control signal arranged to cause packets to be formatted in a second format if the round trip delay is more than or equal to the pre-chosen delay.

17. A method of call handling control for continuous streams of communications data packets in packet switched networks including at least two local area networks in communication with one another across a connecting network, the method comprising:
a) determining an acceptable packet size delay for a call which is to be established between two of the local area networks;
b) comparing actual packet delay to the acceptable packet delay rate; and
c) implementing a large packet size if the delay is greater than the acceptable packet delay.

18. A method according to claim 17, wherein step b) comprises:
a) transmitting a burst of trial data from a first node in the first local area network through the connecting network to a second node in the second local area network;
b) reflecting the burst of trial data received at the second node back to the first node;
c) receiving the reflected burst of trial data at the first node through the connecting network; and
d) comparing the reflected burst of trial data to the transmitted burst of trial data to determine whether a larger packet size can be initiated for the communications traffic from the first node in the first local area network to the second node in the second local area network.

19. A method according to claim 15, comprising:
storing data relating to delayed packets for future use.

20. A method according to claim 17, comprising:
storing data relating to delayed packets for future use.
